(19) United States
(12) Patent Application Publication
(10) Pub. No.: US 2025/0353258 A1
(43) Pub. Date: Nov. 20, 2025

(54) METHOD OF USING METALLIC NANOPOWDERS FOR ENHANCING JOINT STRENGTH BETWEEN DISSIMILAR MATERIALS

(71) Applicant: Edison Welding Institute, Inc, Columbus, OH (US)

(72) Inventors: Jeffrey L. Ellis, Columbus, OH (US); Jeffrey J. Boyce, Columbus, OH (US)

(21) Appl. No.: 19/205,234

(22) Filed: May 12, 2025

Related U.S. Application Data
(63) Continuation-in-part of application No. 18/664,881, filed on May 15, 2024.

(51) Int. Cl. B29C 65/72; B29C 65/00; B29C 65/36

(52) U.S. Cl. CPC B29C 65/72; B29C 65/3676; B29C 66/0246; B29C 66/7422

(57) ABSTRACT

A method for joining dissimilar materials, comprising etching a micropattern into a surface of a first material that is a metal used for creating a part, wherein the micropattern includes various microfeatures; depositing at least one metallic nanopowder on the microfeatures; characterizing the physical characteristics of the microfeatures; characterizing a second material that is a polymer used for creating a part, wherein the characterization includes measuring a degradation temperature of the polymer and measuring a melting point/critical flow temperature of the polymer; placing the polymer on the microfeatures formed on the metal surface to form an interface between the polymer and the metal; applying compressive force to the polymer-metal combination; heating the interface to a temperature falling between the degradation temperature of the polymer and the melting point/critical flow temperature of the polymer; discontinuing heating the interface; and continuing to apply compressive force to the polymer-metal combination until the interface between the polymer and the metal has solidified.

### CROSS-REFERENCE TO RELATED APPLICATIONS

This patent application is a continuation-in-part of U.S. patent application Ser. No. 18/664,881 filed on May 15, 2024, and entitled “System for Joining Dissimilar Materials”, the disclosure of which is hereby incorporated by reference herein in its entirety and made part of the present U.S. utility patent application for all purposes.

### BACKGROUND

The disclosed technology relates in general to systems, methods, and devices for joining dissimilar materials to one another for creating components, parts, and other manufactured items, and more specifically to a system and method for bonding or joining thermoplastic or thermoset polymers to metals and other materials without the use of traditional adhesives or fasteners.

The manufacturing of components, parts, and other items for use in automotive, consumer products, medical, commercial building, government, military, and aerospace applications often involves or requires joining various polymers to metals or other materials. Known technologies for joining these dissimilar materials typically require the use of adhesives and fasteners. However, eliminating such adhesives and fasteners can increase manufacturing throughput, decrease overall manufacturing costs, and can result in smaller and lighter manufactured products. Accordingly, a system and method for joining thermoplastic or thermoset polymers to metals or other materials without the use of traditional adhesives or fasteners would be advantageous for economic and practical reasons.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One embodiment of the disclosed technology provides a first method for joining dissimilar materials, comprising etching a predetermined micropattern into a surface of a first material, wherein the material is a metal used for creating a part, and wherein the micropattern includes various microfeatures; characterizing the physical properties of the microfeatures; characterizing a second material, wherein the second material is a solid polymer used for creating a part, and wherein the characterization includes measuring a degradation temperature of the polymer; and measuring a melting point/critical flow temperature of the polymer; applying metallic nanoparticles to the microfeatures of the micropattern etched into the surface of the first material; placing the polymer on the microfeatures that include the metallic nanoparticles to form an interface between the polymer and the metal; applying a predetermined amount of compressive force to the polymer-metal combination; for a predetermined period of time, heating the interface to a temperature falling between the degradation temperature of the polymer and the melting point/critical flow temperature of the polymer; discontinuing heating the interface; and continuing to apply compressive force to the polymer-metal combination until the interface between the polymer and the metal has solidified and the materials have been joined.

Embodiments of the method further comprise using a 100 W 1064 nm wavelength pulsed fiber laser to etch the predetermined micropattern into the surface of the first material. In certain implementations, the predetermined micropattern includes a crosshatch pattern, a herringbone pattern, a pattern of squares, a pattern of concentric squares, a pattern of circles, or a pattern of concentric circles. In certain implementations, the predetermined micropattern includes parallel lines oriented perpendicular to any pressure gradient present in the part for achieving a hermetic seal between the metal and the polymer. Embodiments of the method further comprise using thermogravimetric analysis to measure the degradation temperature of the polymer. Embodiments of the method further comprise using differential scanning calorimetry to measure the melting point/critical flow temperature of the polymer. Embodiments of the method further comprise using infrared heating to heat the interface between the polymer and the metal. Embodiments of the method further comprise using transmission laser heating to heat the interface between the polymer and the metal. Embodiments of the method using either direct laser heating or transmission laser heating further include shining a 1 μm wavelength continuous laser through the polymer to heat the metal surface at the interface between the polymer and the metal. Embodiments of the method further comprise using an induction coil to heat the interface between the polymer and the metal; or using direct thermal conduction; or using resistive, spin, vibration, or ultrasonic heating. The method may further comprise substituting a different material for the first material, wherein the substituted material has a melting point that is higher than the melting point of the second material. The different material may be a ceramic or a thermoset polymer.

Another embodiment of the disclosed technology provides a second method for joining dissimilar materials, comprising laser etching a predetermined micropattern into a surface of a first material, wherein the material is a metal used for creating a part, and wherein the micropattern includes various microfeatures; characterizing the physical properties of the microfeatures; characterizing a second material, wherein the second material is a solid polymer used for creating a part, and wherein the characterization includes measuring a degradation temperature of the polymer; and measuring a melting point/critical flow temperature of the polymer; applying metallic nanoparticles to the microfeatures of the micropattern etched into the surface of the first material; placing the polymer on the microfeatures that include the metallic nanoparticles to form an interface between the polymer and the metal; applying a predetermined amount of compressive force to the polymer-metal combination; for a predetermined period of time, heating the interface to a temperature falling between the degradation temperature of the polymer and the melting point/critical flow temperature of the polymer; discontinuing heating the interface; continuing to apply compressive force to the polymer-metal combination until the interface between the polymer and the metal has solidified and the materials have been joined; and discontinuing application of the compressive force.

Embodiments of the method further comprise using a 100 W 1064 nm pulsed fiber laser to etch the predetermined micropattern into the surface of the first material. In certain implementations, the predetermined micropattern includes either a crosshatch pattern, a herringbone pattern, a pattern of squares, a pattern of concentric squares, a pattern of circles, or a pattern of concentric circles; or parallel lines oriented perpendicular to any pressure gradient present in the part for achieving a hermetic seal between the metal and the polymer. Embodiments of the method further comprise using thermogravimetric analysis to measure the degradation temperature of the polymer. Embodiments of the method further comprise using differential scanning calorimetry to measure the melting point/critical flow temperature of the polymer. Embodiments of the method further comprise using either infrared heating or an induction coil to heat the interface between the polymer and the metal; or using direct thermal conduction; or using resistive, spin, vibration, or ultrasonic heating. Embodiments of the method further comprise using either direct laser heating or transmission laser heating to heat the interface between the polymer and the metal. Embodiments of the method using transmission laser heating further include shining a 1 μm wavelength continuous laser through the polymer to heat the metal surface at the interface between the polymer and the metal. Embodiments of the method further comprise using an induction coil to heat the interface between the polymer and the metal. The method may further comprise substituting a different material for the first material, wherein the substituted material has a melting point that is higher than the melting point of the second material. The different material may be a ceramic or a thermoset polymer.

Still another embodiment of the disclosed technology provides a third method for joining dissimilar materials, comprising laser etching a predetermined micropattern into a surface of a first material, wherein the material is a metal used for creating a part, and wherein the micropattern includes various microfeatures; characterizing the physical properties of the microfeatures; characterizing a second material, wherein the second material is a solid polymer used for creating a part, and wherein the characterization includes measuring a degradation temperature of the polymer using thermogravimetric analysis; and measuring a melting point/critical flow temperature of the polymer using differential scanning calorimetry; applying metallic nanoparticles to the microfeatures of the micropattern etched into the surface of the first material; placing the polymer on the microfeatures that include the metallic nanoparticles to form an interface between the polymer and the metal; applying a predetermined amount of compressive force to the polymer-metal combination; for a predetermined period of time, heating the interface to a temperature falling between the degradation temperature of the polymer and the melting point/critical flow temperature of the polymer; discontinuing heating the interface; continuing to apply compressive force to the polymer-metal combination until the interface between the polymer and the metal has solidified and the materials have been joined; and discontinuing application of the compressive force.

In certain implementations, the predetermined micropattern includes either a crosshatch pattern, a herringbone pattern, a pattern of squares, a pattern of concentric squares, a pattern of circles, or a pattern of concentric circles; or parallel lines oriented perpendicular to any pressure gradient present in the part for achieving a hermetic seal between the metal and the polymer. Embodiments of the method further comprise using infrared heating, an induction coil, direct laser heating, or transmission laser heating to heat the interface between the polymer and the metal; or using direct thermal conduction; or using resistive, spin, vibration, or ultrasonic heating. The method may further comprise substituting a different material for the first material, wherein the substituted material has a melting point that is higher than the melting point of the second material. The different material may be a ceramic or a thermoset polymer.

Still another embodiment of the disclosed technology provides a fourth method for joining dissimilar materials, comprising etching a predetermined micropattern into a surface of a first material, wherein the material is a metal used for creating a part, and wherein the micropattern includes various microfeatures; characterizing the physical properties of the microfeatures; characterizing a second material, wherein the second material includes an uncured thermoset polymer or viscous thermoplastic polymer used for creating a part, and wherein the characterization includes measuring a degradation temperature of the polymer; and measuring a curing temperature of the polymer; flowing the polymer into the microfeatures; and applying gravitational or compressive force to the polymer-metal combination until the interface between the polymer and the metal has solidified and the materials have been joined. In certain implementations, the predetermined micropattern includes either a crosshatch pattern, a herringbone pattern, a pattern of squares, a pattern of concentric squares, a pattern of circles, or a pattern of concentric circles; or parallel lines oriented perpendicular to any pressure gradient present in the part for achieving a hermetic seal between the metal and the polymer.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1 is a flow chart depicting an example implementation of the disclosed method for joining polymer directly to metal without the use of adhesives or fasteners.

FIG. 2A is an image created from reconstructed three-dimensional data obtained using a non-contact three-dimensional profilometer of an aluminum plate etched with a laser to create a micropattern on the plate. The micropattern includes various microfeatures.

FIG. 2B depicts the image of FIG. 2A showing the cross-sectional region of the etched aluminum plate further depicted in FIG. 2C.

FIG. 2C is a micrograph of the aluminum plate of FIG. 2A depicting the protruding microfeatures within the micropattern etched onto the plate.

FIG. 2D is a graph depicting the physical properties of the various microfeatures including the height of the original material surface, the bottom of the laser path, distance between the laser paths, and the height of material protrusion above the surface of the plate.

FIG. 3 is a cross-sectional view of a polymer (PET) to metal (Al) lap joint created with the disclosed method. As shown in FIG. 3, the polymer has fully filled the microfeatures on the aluminum plate and tungsten carbide (WC) nanoparticles are visible as the bright area in the image near the interface of the polymer and the aluminum.

FIG. 4 is a photograph of a sample part that includes a polyethylene terephthalate (PET) to aluminum butt joint created with the disclosed method.

FIG. 5 is a graph showing a comparison of butt joint strength in constructs made using the disclosed method both with and without the use of metallic nanoparticles (e.g., tungsten carbide (WC) nanopowder. The error bars represent ±1 standard deviation.

FIG. 6 is a cross-sectional view of a joint (made using the disclosed method) analyzed using scanning electron microscopy with energy dispersive x-ray spectroscopy (SEM/EDS). The image shows clusters of WC nanopowder located at the bottom of the troughs etched in the aluminum.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For case of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The disclosed technology provides a system and method for joining thermoplastic or thermoset polymers to metals and other materials without the use of traditional adhesives or fasteners. In an example embodiment, a first aspect of this technology involves functionalizing the surface of a metal part or component by etching a predetermined micropattern having specific microfeatures into the surface of the part or component. This etching is typically accomplished using a laser to create microscale valleys in the surface of the metal. When aluminum, for example, is used for the metal, the melt from the valleys is pushed up the edge of each valley, thereby creating a protrusion with ends that overhang the valley. When stainless steel, for example, is used for the metal, the melt travels slightly less up the sides of the valley, but still creates the desired microfeatures. For both of these metals, and potentially other metals, this process creates a surface that is clean and that includes a mechanically functional topography. Optimization of laser power, pulse width, velocity, number of passes, and geometry creates strong joints between metals and polymers using this method. For example, regarding geometry, a crosshatch pattern confers high joint strength; however, for achieving hermeticity, an etched pattern having parallel lines, perpendicular to any pressure gradient that may be present, is preferred so that no leak path occurs. A 100 W 1064 nm pulsed fiber laser (Laser Marking Technologies) or similar apparatus is suitable for the described laser etching. In alternate implementations, functionalization of the metal (or other material surface) may be accomplished using known chemical methodologies.

In an example embodiment, a second aspect of this technology involves melting a polymer part or component into the functionalized metal surface created by the disclosed etching process. This aspect utilizes both compressive force and heat, which encourages flow of the polymer into the microfeatures. Melting the polymer component may be accomplished using transmission laser heating, wherein a 1 μm continuous laser is directed through the polymer to the metal surface. Direct laser heating may also be utilized. An alternate approach utilizes an induction coil to heat the metal and thus also the polymer at the interface. Both methods employ compression to encourage the viscous melt to fill the metallic microfeatures. Other heating methodologies may be utilized. These methodologies include direct thermal conduction using a hot plate or similar device and resistive, spin, vibration, and ultrasonic heating.

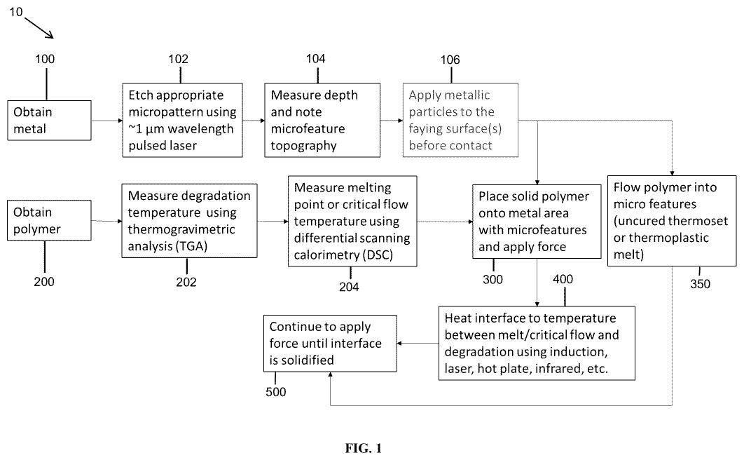

FIG. 1 is a flow chart depicting example implementations of the disclosed method for joining polymer directly to metal without the use of adhesives or fasteners. This method differs from the method disclosed in U.S. application Ser. No. 18/664,881 based on the use of metallic nanoparticles or nanopowders or such as tungsten carbide (WC) nanopowder to increase the strength of the joint formed between polymer and metal. This increased bond strength allows the disclosed method to be used for more structural applications. Example method 10 includes selecting or obtaining a metal at step 100; etching an appropriate micropattern on the metal using a ˜1 μm wavelength pulsed laser at step 102; measuring depth and noting microfeature topography at step 104; applying metallic nanopowder to the microfeatures (i.e., faying surfaces of the microfeatures) at step 106; selecting or obtaining a polymer at step 200; measuring polymer degradation temperature using thermogravimetric analysis (TGA) at step 202; measuring a melting point or critical flow temperature using differential scanning calorimetry (DSC) at step 204 (or measuring a curing temperature (for uncured thermoset or thermoplastic polymers, as described below); placing the polymer onto the metal area having the nanopowder coated microfeatures and applying compressive force at step 300; heating the polymer/metal interface to a temperature between melt/critical flow and degradation using induction, laser, infrared, or hot plate heating methods at step 400; and continuing to apply compressive force until the interface is cooled at step 500.

With reference again to FIG. 1, an alternate implementation includes the use of a thermoplastic polymer, which is initially heated to a temperature at which it flows as a viscous melt (while remaining below the degradation temperature of the polymer); flowing the heated polymer onto the microfeatures (see step 350 of FIG. 1); and applying compressive force to the polymer-metal combination until the interface between the polymer and the metal has solidified and the materials have been joined. The method may be accomplished as an insert injection molding operation. Still another alternate implementation includes the use of an uncured thermoset polymer; flowing the polymer onto the microfeatures (see step 350 of FIG. 1); using gravity or the addition of compressive force to fill the microfeatures with the polymer; and waiting until thermoset solidification has occurred before moving the joined part.

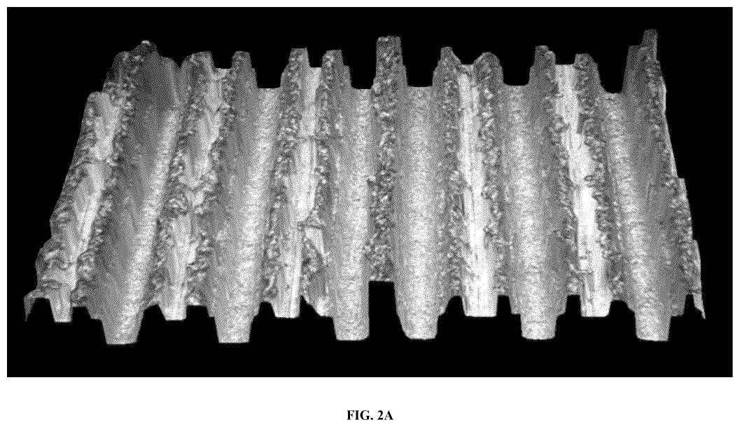

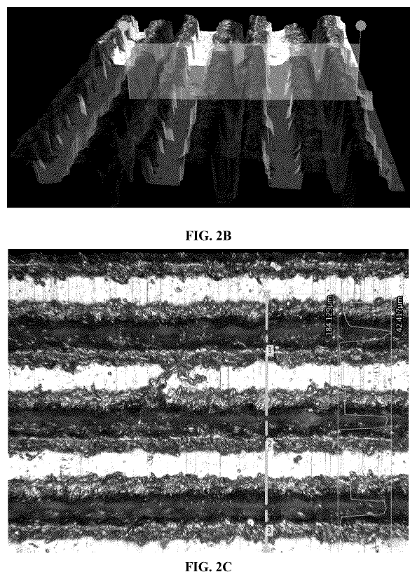

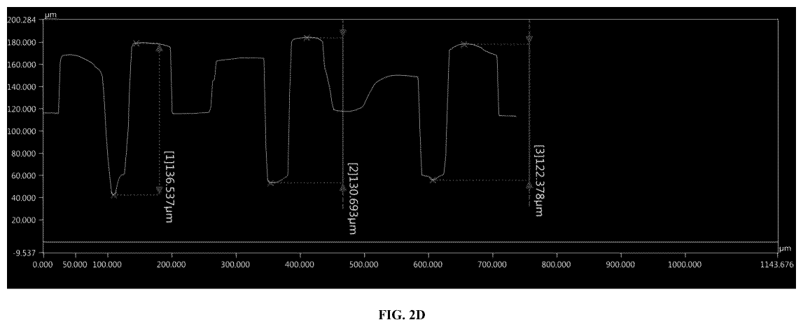

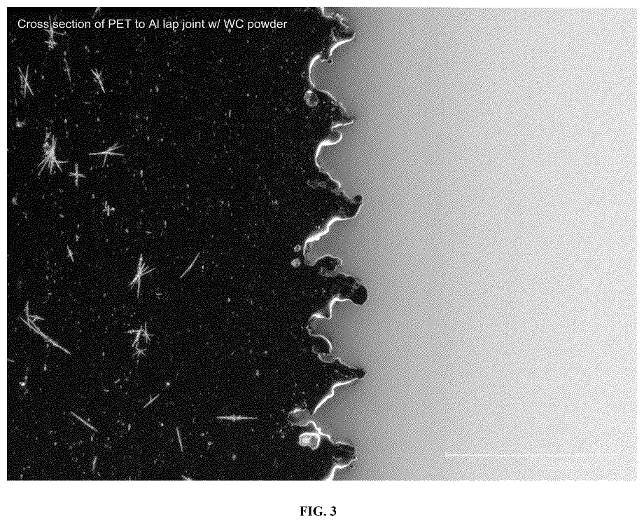

FIG. 2A provides an image created from reconstructed three-dimensional data obtained using a non-contact three-dimensional profilometer of an aluminum plate etched with a laser to create a micropattern on the plate. The micropattern includes various microfeature including channels having widths of about 50-100 μm and wells having overhanging fingers or bridges that enhance joint strength after the polymer has been melted into the wells (see FIG. 3). FIG. 2B depicts the image of FIG. 2A showing the cross-sectional region of the etched aluminum plate further depicted in FIG. 2C, which is a micrograph of the aluminum plate of FIG. 2A depicting the protruding microfeatures within the micropattern etched onto the plate. FIG. 2D is a graph depicting the physical properties of the various microfeatures including the height of the original material surface (troughs in the middle region of the image), the bottom of the laser path (troughs in the middle region of the image having a depth of about 60 μm), distance between the laser paths, and the height of material protrusion above the surface of the plate (peaks in the upper region of the image of about 40-60 μm).

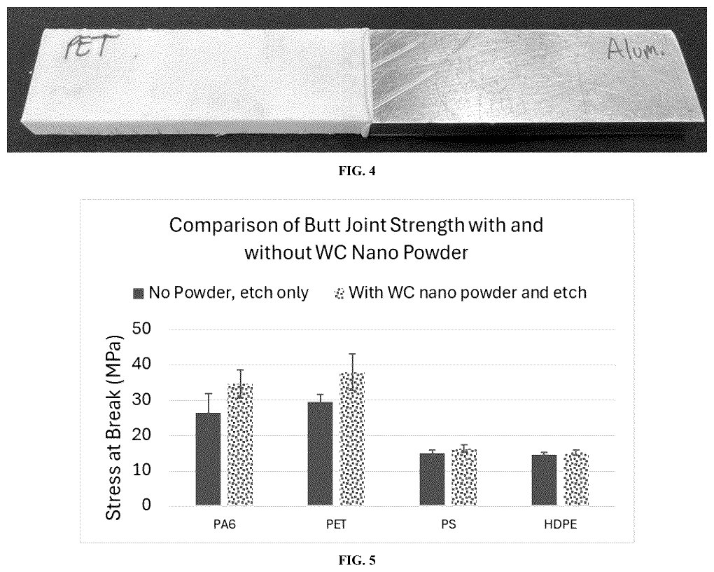

FIG. 3 provides a cross-sectional view of a polymer (PET) to metal (Al) lap joint created with the disclosed method. As shown in FIG. 3, the polymer has fully filled the microfeatures on the aluminum plate and tungsten carbide (WC) nanoparticles are visible as the bright area in the image near the interface of the polymer and the aluminum. FIG. 4 is a photograph of a sample part that includes a polyethylene terephthalate (PET) to aluminum butt joint created with the disclosed method.

FIG. 5 is a graph showing a comparison of butt joint strength in constructs made using the disclosed method both with and without the use of metallic nanoparticles (e.g., tungsten carbide (WC) nanopowder. The error bars represent ±1 standard deviation. Table 1, below, provides a butt joint strength comparison with and without the use of metallic powder in the disclosed method.

TABLE 1
Butt joint strength comparison with and without metallic powder.

| | Stress at Break (MPa) | | | | |
|---|---|---|---|---|---|
| | | With WC | | | Statistically |
| | No Powder, | nano powder | % | | Significant |
| Material | etch only | and etch | Change | t-test | Difference |
| PA6 | 26.3 | 34.5 | 31.3% | 0.043 | Yes |
| PET | 29.5 | 37.9 | 28.5% | 0.031 | Yes |
| PS | 15.0 | 16.2 | 8.4% | 0.112 | No |
| HDPE | 14.5 | 15.0 | 3.8% | 0.283 | No |

Example polymers used to generate the data in TABLE 1 included polyamide 6 (PA6), polyethylene terephthalate (PET), polystyrene (PS), and high density polyethylene (HDPE). The metal used was 5052 aluminum. The metallic powder used was tungsten carbide (WC) with a median particle size of 600 nm and a mean particle size of 1130 nm. Test samples were configured with a butt joint geometry with a joint area of 161 mm² (see FIG. 4). Butt joint samples were pulled in tension using a universal test stand and the stress at break was recorded. TABLE 1 and FIG. 5 show the results of this testing. For the more polar polymers, PA6 and PET, the WC powder made the joint statistically significantly stronger than the same materials without the WC powder. For the polymers that are less polar (PS) or non-polar (HDPE), there was still an increase in strength with the addition of the powder, but it was not statistically significant. The additional strength for the more polar polymers is explained by the additional surface area the WC powder add at the polymer to metal interface. The additional surface area allows for increased covalent bonding between the carbonyls (C═O) on the polymer backbone and the metal due to the lone pair of electrons on the oxygen. This is described in detail by Liu et al. [1], where it is referred to as C—O-M type covalent bonding that occurs between metal (-M) and polymer (C═O).

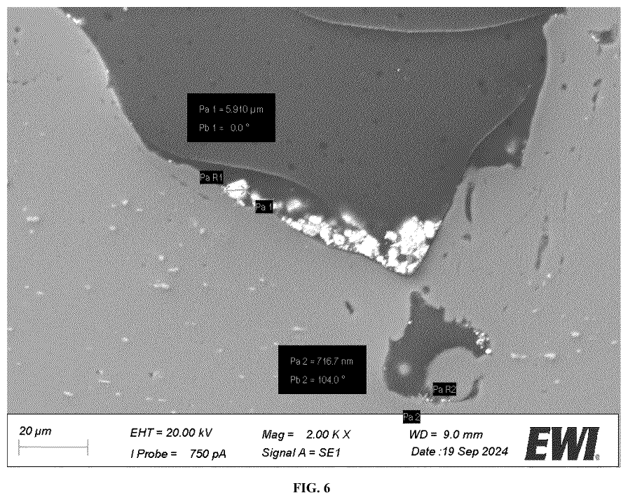

FIG. 6 is a cross-sectional view of a joint (made using the disclosed method) analyzed using scanning electron microscopy with energy dispersive x-ray spectroscopy (SEM/EDS). The image shows clusters of WC nanopowder located at the bottom of the troughs etched in the aluminum.

The disclosed method can be used for the creation of components and parts having more complex geometries, such as cylindrical pipe geometrics. With regard to this example geometry, laser etching may include a thin flat aluminum component etched on both sides that is placed on the inner diameter of a cylindrical pipe. Joining would include sliding a polymer fitting onto the end of the pipe and using an induction crimping tool to apply heat and force to create polymer melt flow into laser-created microfeatures. An example cycle time for this method is 30 seconds. Numerous other implementations and applications of the disclosed method are possible.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

The following reference forms part of the specification of the present application and this reference is incorporated by reference herein, in its entirety, for all purposes.
[1] Liu, F. C., Dong, P., Lu, W., and Sun, K. 2019. On formation of AlOC bonds at aluminum/polyamide joint interface. Applied Surface Science 466:202-9. DOI: 10.1016/j.apsusc.2018.10.024

What is claimed:

1. A method for joining dissimilar materials, comprising:
(a) etching a predetermined micropattern into a surface of a first material, wherein the material is a metal used for creating a part, and wherein the micropattern includes various microfeatures;
(b) characterizing the physical properties of the microfeatures;
(c) characterizing a second material, wherein the second material is a polymer used for creating a part, and wherein the characterization includes:
(i) measuring a degradation temperature of the polymer; and
(ii) measuring a melting point/critical flow temperature of the polymer;
(d) applying metallic nanoparticles to the microfeatures of the micropattern etched into the surface of the first material;
(e) placing the polymer on the microfeatures that include the metallic nanoparticles to form an interface between the polymer and the metal;
(f) applying a predetermined amount of compressive force to the polymer-metal combination;
(g) for a predetermined period of time, heating the interface to a temperature falling between the degradation temperature of the polymer and the melting point/critical flow temperature of the polymer;
(h) discontinuing heating the interface; and
(i) continuing to apply compressive force to the polymer-metal combination until the interface between the polymer and the metal has solidified and the materials have been joined.

2. The method of claim 1, further comprising using a 100 W 1064 nm wavelength pulsed fiber laser to etch the predetermined micropattern into the surface of the first material.

3. The method of claim 1, wherein the predetermined micropattern includes a crosshatch pattern, a herringbone pattern, a pattern of squares, a pattern of concentric squares, a pattern of circles, or a pattern of concentric circles; or wherein the predetermined micropattern includes parallel lines oriented perpendicular to any pressure gradient present in the part for achieving a hermetic seal between the metal and the polymer.

4. The method of claim 1, wherein the metallic nanoparticles include tungsten carbide.

5. The method of claim 1, further comprising using thermogravimetric analysis to measure the degradation temperature of the polymer and using differential scanning calorimetry to measure the melting point/critical flow temperature of the polymer.

6. The method of claim 1, further comprising using infrared heating to heat the interface between the polymer and the metal.

7. The method of claim 1, further comprising using either direct laser heating or transmission laser heating to heat the interface between the polymer and the metal, wherein using transmission laser heating further includes shining a 1 μm wavelength continuous laser through the polymer to heat the metal surface at the interface between the polymer and the metal.

8. The method of claim 1, further comprising using an induction coil to heat the interface between the polymer and the metal; or using direct thermal conduction; or using resistive, spin, vibration, or ultrasonic heating.

9. The method of claim 1, further comprising substituting a different material for the first material, wherein the substituted material has a melting point that is higher than the melting point of the second material, and wherein the different material includes a ceramic or a thermoset polymer.

10. A method for joining dissimilar materials, comprising:
(a) laser etching a predetermined micropattern into a surface of a first material, wherein the material is a metal used for creating a part, and wherein the micropattern includes various microfeatures;
(b) characterizing the physical properties of the microfeatures;
(c) characterizing a second material, wherein the second material is a solid polymer used for creating a part, and wherein the characterization includes:
(i) measuring a degradation temperature of the polymer; and
(ii) measuring a melting point/critical flow temperature of the polymer;
(d) applying metallic nanoparticles to the microfeatures of the micropattern etched into the surface of the first material;
(e) placing the polymer on the microfeatures that include the metallic nanoparticles to form an interface between the polymer and the metal;
(f) applying a predetermined amount of compressive force to the polymer-metal combination;
(g) for a predetermined period of time, heating the interface to a temperature falling between the degradation temperature of the polymer and the melting point/critical flow temperature of the polymer;
(h) discontinuing heating the interface;
(i) continuing to apply compressive force to the polymer-metal combination until the interface between the polymer and the metal has solidified and the materials have been joined; and
(j) discontinuing application of the compressive force.

11. The method of claim 10, further comprising using a 100 W 1064 nm wavelength pulsed fiber laser to etch the predetermined micropattern into the surface of the first material.

12. The method of claim 10, wherein the predetermined micropattern includes a crosshatch pattern, a herringbone pattern, a pattern of squares, a pattern of concentric squares, a pattern of circles, or a pattern of concentric circles; or parallel lines oriented perpendicular to any pressure gradient present in the part for achieving a hermetic seal between the metal and the polymer.

13. The method of claim 10, further comprising using thermogravimetric analysis to measure the degradation temperature of the polymer and using differential scanning calorimetry to measure the melting point/critical flow temperature of the polymer.

14. The method of claim 10, further comprising using either infrared heating or an induction coil to heat the interface between the polymer and the metal; or using direct thermal conduction; or using resistive, spin, vibration, or ultrasonic heating.

15. The method of claim 10, further comprising using either direct laser heating or transmission laser heating to heat the interface between the polymer and the metal, wherein using transmission laser heating further includes shining a 1 μm wavelength continuous laser through the polymer to heat the metal surface at the interface between the polymer and the metal.

16. The method of claim 10, further comprising substituting a different material for the first material, wherein the substituted material has a melting point that is higher than the melting point of the second material, wherein the different material includes a ceramic or a thermoset polymer.

17. A method for joining dissimilar materials, comprising:
(a) laser etching a predetermined micropattern into a surface of a first material, wherein the material is a metal used for creating a part, and wherein the micropattern includes various microfeatures;
(b) characterizing the physical properties of the microfeatures;
(c) characterizing a second material, wherein the second material is a solid polymer used for creating a part, and wherein the characterization includes:
(i) measuring a degradation temperature of the polymer using thermogravimetric analysis; and
(ii) measuring a melting point/critical flow temperature of the polymer using differential scanning calorimetry;
(d) applying nanoparticles of tungsten carbide to the microfeatures of the micropattern etched into the surface of the first material;
(e) placing the polymer on the microfeatures that include the metallic nanoparticles to form an interface between the polymer and the metal;
(f) applying a predetermined amount of compressive force to the polymer-metal combination;
(g for a predetermined period of time, heating the interface to a temperature falling between the degradation temperature of the polymer and the melting point/critical flow temperature of the polymer;
(h) discontinuing heating the interface;
(i) continuing to apply compressive force to the polymer-metal combination until the interface between the polymer and the metal has solidified and the materials have been joined; and
(j) discontinuing application of the compressive force.

18. The method of claim 17, wherein the predetermined micropattern includes either a crosshatch pattern, a herringbone pattern, a pattern of squares, a pattern of concentric squares, a pattern of circles, or a pattern of concentric circles; or parallel lines oriented perpendicular to any pressure gradient present in the part for achieving a hermetic seal between the metal and the polymer.

19. The method of claim 17, further comprising using infrared heating, an induction coil, direct laser heating, or transmission laser heating to heat the interface between the polymer and the metal; or using direct thermal conduction; or using resistive, spin, vibration, or ultrasonic heating.

20. The method of claim 17, further comprising substituting a different material for the first material, wherein the substituted material has a melting point that is higher than the melting point of the second material, wherein the different material includes a ceramic or a thermoset polymer.

21. A method for joining dissimilar materials, comprising:
(a) etching a predetermined micropattern into a surface of a first material, wherein the material is a metal used for creating a part, and wherein the micropattern includes various microfeatures;
(b) characterizing the physical properties of the microfeatures;
(c) characterizing a second material, wherein the second material is an uncured thermoset polymer or viscous thermoplastic polymer used for creating a part, and wherein the characterization includes:
(i) measuring a degradation temperature of the polymer; and
(ii) measuring a curing temperature of the polymer;
(d) flowing the polymer into the microfeatures; and
(e) applying gravitational or compressive force to the polymer-metal combination until the interface between the polymer and the metal has solidified and the materials have been joined.

22. The method of claim 21, wherein the predetermined micropattern includes a crosshatch pattern, a herringbone pattern, a pattern of squares, a pattern of concentric squares, a pattern of circles, or a pattern of concentric circles.

23. The method of claim 21, wherein the predetermined micropattern includes parallel lines oriented perpendicular to any pressure gradient present in the part for achieving a hermetic seal between the metal and the polymer.
